(19) United States
(12) Patent Application Publication
(10) Pub. No.: US 2014/0141139 A1
(43) Pub. Date: May 22, 2014

(54) Membrane Separation Process for Controlling Gas Concentrations Within Produce Shipping or Storage Containers

(71) Applicants: Douglas Gottschlich, Redwood City, CA (US); Jonathan S. Tan, San Francisco, CA (US)

(72) Inventors: Douglas Gottschlich, Redwood City, CA (US); Jonathan S. Tan, San Francisco, CA (US)

(73) Assignee: Membrane Technology and Research, Inc., Newark, CA (US)

(21) Appl. No.: 13/800,613

(22) Filed: Mar. 13, 2013

Related U.S. Application Data
(60) Provisional application No. 61/728,013, filed on Nov. 19, 2012.

(51) Int. Cl. A23B 7/152

(52) U.S. Cl. CPC A23B 7/152
USPC 426/418; 99/467; 99/472; 99/473

(57) ABSTRACT

Disclosed herein is a membrane separation process and system for controlling the relative concentrations of carbon dioxide, oxygen, and nitrogen within a shipping or storage container containing respiring produce. The process uses a first membrane that is selective to carbon dioxide over oxygen and nitrogen, and a second membrane that is selective to oxygen over nitrogen.

### FIELD OF THE INVENTION

The invention relates to a membrane separation process for controlling the relative concentrations of carbon dioxide, oxygen, and nitrogen within a shipping or storage container containing respiring produce. The process uses a first membrane that is selective to carbon dioxide over oxygen and nitrogen, and a second membrane that is selective to oxygen over nitrogen.

### BACKGROUND OF THE INVENTION

Produce is typically shipped long distances to market, making it difficult to keep the produce in a desired state of freshness and ripeness. Aside from the length of time involved, such produce is respiring, which produces carbon dioxide and changes the composition of the atmosphere around the produce.

The gas composition and the temperature surrounding the produce exert a direct effect on its freshness and ripeness. Controlled atmosphere (CA) systems, designed for use in sea van containers or the like, can regulate the concentration of oxygen, nitrogen, and carbon dioxide around a perishable product. Typically, the oxygen concentration is reduced to subatmospheric levels, whereas the carbon dioxide level may be either raised or lowered.

The preferred relative concentrations of oxygen and carbon dioxide are often specific to a particular perishable commodity. Ideally, the preferred concentrations would be maintained inside a shipping container throughout the journey, protecting the perishables from deterioration as they are transported to their intended markets.

Numerous systems exist to control both carbon dioxide and oxygen levels in a shipping container environment. Engineering complexity, and associated service and maintenance, make some systems unreliable or commercially prohibitive to operate. Others rely on large quantities of hydrated lime (calcium hydroxide) packed in the shipping container with the cargo to selectively remove or control carbon dioxide levels. Hydrated lime systems are expensive, bulky, take valuable cargo space, and the spent lime presents a disposal problem at destination ports.

A number of previously proposed solutions to controlling gas concentrations in produce storage or shipping containers are described below.

U.S. Pat. Nos. 4,817,391 and 5,152,966, to Roe et al., describe a method for producing a controlled atmosphere that includes the intermittent removal of oxygen, carbon dioxide, water vapor, and ethylene. Apparatus includes one or two compressors to increase the pressure of the gases, which are then separated by diffusion across membranes.

U.S. Pat. No. 5,120,329, to Sauer et al., describes a method for providing a controlled atmosphere in a food storage facility that comprises feeding gas from the facility to a membrane having higher permeability to carbon dioxide than to nitrogen, recycling the carbon dioxide-depleted residue to the facility, and venting the carbon dioxide-rich permeate. This system requires the use of a number of sensors and detectors.

U.S. Pat. No. 5,342,637, to Kusters et al., describes a method for conditioning the atmosphere in a storage chamber for organic harvested produce. The storage chamber forms part of a system that also includes at least two (and, preferably, three) nitrogen/oxygen membrane separation modules located downstream of one another, at least one compressor, and at least one control valve.

U.S. Pat. No. 5,457,963, to Cahill-O'Brien et al., describes operation of an atmospheric control system. The system is electrically controlled, and includes temperature, pressure, and concentration sensors.

U.S. Pat. Nos. 5,623,105; 5,801,317; and 6,092,430, to Liston et al., describe a controller for use in a membrane system to maintain a desired atmosphere within a refrigerated container. The controller is electrically interfaced to a sensor that measures the levels of oxygen and carbon dioxide within the container.

U.S. Pat. No. 5,649,995, to Gast, Jr. describes a nitrogen generation control system and method for controlling levels of nitrogen and oxygen in a container for perishable goods. The system generates controlled amounts of nitrogen, which are injected into the container. A sample analyzer subsystem is connected to the container to extract a sample of gases from the controlled environment and to analyze the oxygen content. The control system further includes a cascaded, dual control loop controller coupled to the nitrogen generator and sample analyzer subsystem.

U.S. Pat. No. 6,007,603, to Garrett, describes an atmospheric control system that utilizes a first membrane separation apparatus to separate nitrogen, and a second separation apparatus to separate carbon dioxide and water vapor, from the container. The separated nitrogen and at least a portion of the carbon dioxide and water vapor are returned to the container to maintain a desired atmosphere.

U.S. Pat. No. 7,601,202, to Noack et al., describes a method for reducing the carbon dioxide concentration in a closed or partially enclosed space that includes removing an air flow from the space and passing it through at least one membrane module having a carbon dioxide/oxygen selectivity greater than 2. The carbon dioxide-depleted residue is then returned to the unit of space. The method may optionally be combined with an oxygen enrichment method.

U.S. Pat. No. 7,866,258, to Jorgensen et al., describes an apparatus for controlling the composition of gases within a cargo container which includes at least one sensor, at least one controller, and at least one gas permeable membrane adapted to facilitate the passage of different gases at different rates.

U.S. Pat. No. 8,177,883 also to Jorgensen et al., describes a controlled atmosphere container that includes a gas composition control apparatus, at least one sensor, at least one controller, and at least one gas permeable membrane through which different gases pass at different rates. The air in the container is in communication with the ambient atmosphere through one or more vacuum pumps.

U.S. Published Application No. 2007/0144638, of Fernandez et al., describes a device for controlling the air composition within a storage chamber, where at least a portion of the chamber wall is made up of a selectively gas-permeable membrane in communication with the outside atmosphere. The chamber also, includes a channel that transmits gas from the chamber to the container, and a channel that transmits gas from the container to the chamber.

U.S. Published Application No. 2011/0296984, of Macleod et al., describes a scrubber and method for controlling carbon dioxide levels that utilizes a gas-selective membrane having a carbon dioxide/oxygen selectivity ratio greater than 1:1.

It would be desirable to provide a simpler method of controlling the concentrations of various gases within a shipping or storage container containing fresh, produce that required fewer sensors or controllers.

### SUMMARY OF THE INVENTION

Disclosed herein is a membrane separation process for controlling the relative concentrations of carbon dioxide, oxygen, and nitrogen within the interior of a storage or shipping container containing respiring produce. The method of the invention comprises the following basic steps:

(a) providing a first membrane unit containing a first membrane having a first feed side and a first permeate side, wherein the first membrane exhibits a selectivity to carbon dioxide over oxygen and nitrogen, and wherein the first feed side is in gas-transferring communication with the interior, such that gas may flow from the container, across the first feed side and back to the container;

(b) providing a first driving force for transmembrane permeation from the first feed side to the first permeate side;

(c) passing carbon dioxide-rich air from the interior as a first feed stream across the first feed side at a first feed flow rate, F1 scfm;

(d) withdrawing from the first feed side at a first residue flow rate, R1 scfm, a first residue stream depleted in carbon dioxide compared with the first feed stream;

(e) returning the first residue stream to the interior;

(f) withdrawing from the first permeate side at a first permeate flow rate, P1 scfm, a first permeate stream enriched in carbon dioxide compared with the first feed stream;

(g) discharging the first permeate stream to an outside environment;

(h) providing a second membrane unit containing a second membrane having a second feed side and a second permeate side, wherein the second membrane exhibits a selectivity to oxygen over nitrogen, and wherein the second membrane unit is positioned in an air intake line that provides gas flow, unregulated except by any resistance provided by the second membrane unit, from an outside source of fresh air to the interior;

(i) providing a second driving force for transmembrane permeation from the second feed side to the second permeate side;

(j) allowing a fresh air stream to be drawn into the air intake line in a passive, unregulated manner, thereby creating a second feed stream that passes across the second feed side at a second feed flow rate, F2 scfm;

(k) allowing a second residue stream, having a second residue flow rate, R2 scfm, depleted in oxygen compared with the second feed stream and created by passage of the second feed stream over the second feed side, to be drawn in a passive, unrestrained manner into the interior;

(l) withdrawing from the second permeate side at a second permeate flow rate, P2 scfm, a second permeate stream enriched in oxygen compared with the second feed stream;

(m) discharging the second permeate stream to the outside environment;

wherein steps (j) and (k) result substantially in the relationships:

F2=P1+P2, and

R2=F1−R1.

The method of the invention involves two membrane separation steps: the first to preferentially remove carbon dioxide from the container gas mixture, thereby controlling the carbon dioxide content within the container, and the second to preferentially remove oxygen from the make-up air entering the container. Unlike previous processes and systems that use two membrane separation units, the operation of the second membrane separation unit or step is essentially passive. In other words, no sensors, switches, valves, regulators, or the like are used to start or stop the second membrane separation step. Rather, it operates in an unregulated manner, by which we mean that the only driving force to draw the make-up air into the second membrane unit is the pressure differential, between the air inside the container and the outside air.

As the concentration of carbon dioxide builds up within the container, some of the carbon dioxide is removed by the first membrane. Removal of the first, carbon dioxide-enriched permeate stream causes the pressure within the container to drop to less than atmospheric (or whatever is the outside pressure). To compensate for the pressure drop within the container, an amount of “make-up” air (at a flow rate F2 scfm) flows into the container. This air flows, unimpeded except for any resistance along the channels of the membrane modules themselves, through the second membrane unit to the container. The membrane unit selectively removes some of the oxygen in the ambient air, thereby bringing in oxygen-depleted air to the container and reducing the overall oxygen concentration therein.

As set forth above, the process of the invention results substantially in the flow rate relationships:

F2=P1+P2, and

R2=F1−R1.

By “substantially”, we mean that one of skill in the art will recognize that our teachings mean that the flow rate F2 to the second membrane unit averaged over time must essentially balance the flow out (P1+P2), subject to any leaks in or out. However, because flow F2 is passive, at any specific moment actual ambient conditions may cause the flow to deviate slightly (such as a few percent) from the amount needed to maintain an exact flow balance.

The selectivity of the first membrane to carbon dioxide over oxygen and nitrogen does not need to be particularly high, as only some (and not all) of the carbon dioxide needs to be removed from the air in the container. Typically, the first membrane exhibits a selectivity to carbon dioxide over oxygen of at least 2.5, preferably, at least 4 or 5 and, more preferably, at least 8 or 10; a selectivity to carbon dioxide over nitrogen of at least 5, preferably, at least 8 or 10 and, more preferably, at least 12 or 15; and a carbon dioxide permeance of at least 400 gpu, preferably, at least 500 gpu and, more preferably, at least 800 gpu. The first membrane can be driven by compressor, vacuum, or a sweep stream of air, oxygen, or oxygen-enriched air.

The second membrane typically exhibits a selectivity to oxygen over nitrogen of at least 1.5, preferably, at least 2 and more preferably, at least 2.5, as well as an oxygen permeance of at least 100 gpu, preferably, at least 200 gpu and more preferably, at least 500 gpu.

Typically, the first membrane unit and the second membrane unit are constructed as a single unit, with this unit being mounted inside the shipping or storage container. The first and second permeate streams are typically combined and discharged by means of a single vacuum pump.

Also disclosed herein is a produce storage or shipment system including the following basic elements:

(a) a produce storage or shipping container;

(b) air intake means for conveying air into the container;

(c) air output means for discharging air from the container;

(d) a first membrane unit containing a first membrane having a first feed side and a first permeate side, wherein the first membrane is selective for permeating carbon dioxide over oxygen and nitrogen, and wherein the first permeate side is in gas transferring communication with the air output means and the first feed side is in gas transferring communication with the interior of the container; and

(e) a second membrane unit containing a second membrane having a second feed side and a second permeate side, wherein the second membrane is selective for permeating oxygen over nitrogen, and wherein the second permeate side is in gas transferring communication with the air output means, and wherein the second membrane unit is adapted to accept fresh air intake in a passive, unregulated manner on the second feed side, and to deliver an oxygen-depleted second residue stream in a passive, unregulated manner to the interior of the container.

Typically, the first membrane unit and the second membrane unit are constructed as a single unit, which unit is mounted inside the container. The air output means typically includes a vacuum pump, which is activated by the carbon dioxide-depleted first permeate stream.

The system may also include at least one compressor, at least one vacuum pump, and/or means for providing a sweep stream of air, oxygen, or oxygen-enriched air to the first permeate side. The system may further include a fan to increase air flow to the second membrane unit.

The first membrane typically exhibits a selectivity to carbon dioxide over oxygen of at least 2.5, preferably, at least 4 or 5 and, more preferably, at least 8 or 10; a selectivity to carbon dioxide over nitrogen of at least 5, preferably, at least 8 or 10 and, more preferably, at least 12 or 15; and a carbon dioxide permeance of at least 400 gpu, preferably, at least 500 gpu and, more preferably, at least 800 gpu, under membrane operating conditions.

The second membrane typically exhibits a selectivity to oxygen over nitrogen of at least 1.5, preferably, at least 2 and, more preferably, at least 2.5, as well as an oxygen permeance of at least 100 gpu, preferably, at least 200 gpu and, more preferably, at least 500 gpu, under membrane operating conditions.

### BRIEF DESCRIPTION OF THE DRAWINGS

FIG. 1 is a schematic drawing of a basic embodiment of the process and produce storage or shipment system of the invention for controlling the relative concentrations of carbon dioxide, oxygen, and nitrogen within the container.

### DETAILED DESCRIPTION OF THE INVENTION

Gas percentages given herein are by volume unless stated otherwise. Optimum gas percentages for a storage or shipping container containing respiring produce are within the ranges of 0 to 10% carbon dioxide and 0 to 10% oxygen (balance is nitrogen and other inert, gases), as shown in Table 1, below.

TABLE 1
Storage Parameters for Various Fruits and Vegetables

| | Optimal | Optimal | Produce | Annual |
|---|---|---|---|---|
| | Atmo- | Atmo- | Respiration | Production |
| Type of | spheric O₂ | spheric CO₂ | Rate | in the U.S. |
| Produce | Content (%) | Content (%) | (ml CO₂/kg/h) | (million tons) |
| Apples | 1-3 | 1.5-3 | 3-6 | 4.2 |
| Lettuce | 0-1 | 10 | 6-10 | 4.4 |
| Mangoes | 3-5 | 5-8 | 15-22 | 0.3 |
| Melons | 3 | 10 | 7-9 | 1.9 |
| Onions | 3 | 5-7 | 3-4 | 3.6 |
| Oranges | 5-10 | 0-5 | 2-4 | 7.4 |
| Peaches | 1-2 | 3-5 | 2-12 | 1.0 |
| Tomatoes | 3-5 | 1-3 | 8-14 | 14.2 |

Pressures as given herein are in bar absolute unless stated otherwise.

The term “outside environment”, as used herein means any environment, whether outdoor or indoor, outside of the shipping, container and membrane system(s).

For convenience and consistency, all flow rates referred to herein are expressed in scfm.

The processes of the invention are particularly applicable for storage or shipping of produce (such as bananas) that is sensitive to the relative concentrations of various gases within the shipping or storage unit.

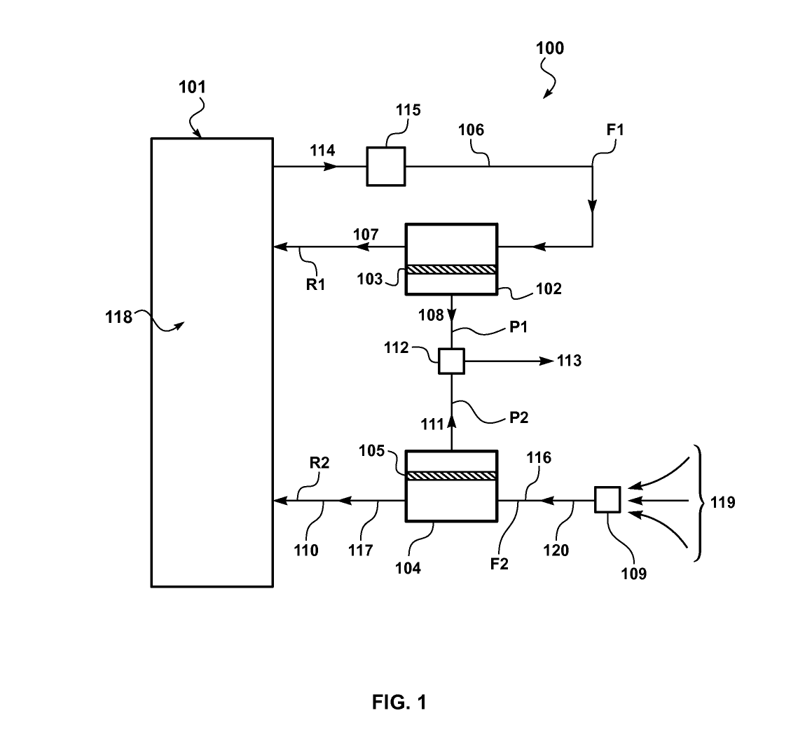

A basic embodiment of the process and produce storage or shipment system of the invention is shown in FIG. 1. It will be appreciated by those of skill in the art that the appended figure is a very simple block diagram, intended to make clear the key unit operations of the embodiment processes of the invention, and that actual process train may include additional steps of a standard type, such as heating, chilling, compressing, condensing, pumping, various types of separation and/or fractionation, as well as monitoring of pressures, temperatures, flows, and the like, as long as these do not result in regulating the feed gas flow to the second membrane unit. It will also be appreciated by those of skill in the art that the details of the unit operations may differ from process to process.

For the sake of simplicity, the process illustrated in FIG. 1 shows first membrane unit, 102, and second membrane unit, 104, located outside of a produce storage or shipping container, 101. Typically, first and second membrane units 102 and 104 each comprise a single membrane module and are located inside container 101 and, often, the two membrane modules are housed or mounted together as a single unit.

The first membrane separation step or unit may operate continuously or intermittently as desired. Typically, but not necessarily, a concentration sensor (not shown in the figure) can be used to detect build-up of carbon dioxide in the container. When the carbon dioxide level exceeds a predetermined value, the first membrane separation step is started by blowing or pumping a carbon dioxide-rich gas stream, 114, from the container 101, to the first membrane unit or step, 102, by means of a fan, blower, or pump, 115. Optionally, stream 114 may be cooled before it enters the first membrane unit or step.

The optionally cooled stream, 106, is then sent for treatment in the first membrane unit 102, which contains membranes, 103, that are selectively permeable to carbon dioxide over oxygen, and to carbon dioxide over nitrogen.

The selectivity of the first membrane to carbon dioxide over oxygen and nitrogen does not need to be particularly high, as only some (and not all) of the carbon dioxide needs to be removed from the air in the container. Typically, the first membrane 103 typically exhibits a selectivity to carbon dioxide over oxygen of at least 2.5, preferably, at least 4 or 5 and, more preferably, at least 8 or 10; a selectivity to carbon dioxide over nitrogen of at least 5, preferably, at least 8 or 10 and, more preferably, at least 12 or 15; and a carbon dioxide permeance of at least 400 gpu, preferably, at least 500 gpu and, more preferably, at least 800 gpu. The first membrane can be driven by compressor, vacuum, or a sweep stream of air, oxygen, or oxygen-enriched air, as is known in the art.

Any membranes with suitable performance properties may be used. Many polymeric materials, especially polar elastomeric materials, are very permeable to carbon dioxide. Preferred membranes for separating carbon dioxide from nitrogen or other inert gases have a selective layer based on a polyether. A number of membranes are known to have high carbon dioxide/nitrogen selectivity, such as 30, 40, 50, or above, and carbon dioxide/oxygen selectivity of 10, 15, 20, or above (although the selectivity may be lower under actual operating conditions). A representative preferred material for the selective layer is Pebax®, a polyamide-polyether block copolymer material described in detail in U.S. Pat. No. 4,963,165. We have found that membranes using Pebax® as the selective polymer can maintain a carbon dioxide/nitrogen selectivity of 20 or greater under process conditions.

One feature of the invention is that membranes of very high selectivity are not required for either membrane step. Typically, it is preferred that the membrane used for the carbon dioxide separation step has a selectivity for carbon dioxide over nitrogen of at least about 5, and the membrane used for the oxygen-depletion step has a selectivity for oxygen over nitrogen of at least about 2, both as determined under the operating conditions of the process. Representative membrane materials that can be used as the selective membrane layer for either or both steps include, but are not limited to, rubbery materials, such as nitrile rubber, neoprene, silicones rubbers, fluoroelastomers, polyurethanes, butadiene-based polymers and copolymers, and polyether-based polymers and copolymers; and glassy polymers such as polysulfones, polycarbonates, polyimides, polyamides, cellulose derivatives and fluorinated dioxoles.

The membrane may take the form of a homogeneous film, an integral asymmetric membrane, a multilayer composite membrane, a membrane incorporating a gel or liquid layer or particulates, or any other form known in the art. If elastomeric membranes are used, the preferred form is a composite membrane including a microporous support layer for mechanical strength and a rubbery coating layer that is responsible for the separation properties.

The membranes may be manufactured as flat sheets or as fibers and housed in any convenient module form, including spiral-wound modules, plate-and-frame modules, and potted hollow-fiber modules. The making of all these types of membranes and modules is well known in the art. To provide countercurrent flow of the sweep gas stream, the modules preferably take the form of hollow-fiber modules, plate-and-frame modules, or spiral-wound modules.

Flat-sheet membranes in spiral-wound modules is the most preferred choice for the membrane/module configuration. A number of designs that enable spiral-wound modules to be used in counterflow mode with or without sweep on the permeate side have been devised. A representative example is described in U.S. Pat. No. 5,034,126, to Dow Chemical.

Membrane unit 102 may contain a single membrane module or bank of membrane modules or an array of modules. A single unit or stage containing one or a bank of membrane modules is adequate for many applications. If the residue stream requires further purification, it may be passed to a second bank of membrane modules for a second processing step. If the permeate stream requires further concentration, it may be passed to a second bank of membrane modules for a second-stage treatment. Such multi-stage or multi-step processes, and variants thereof; will be familiar to those of skill in the art, who will appreciate that the membrane separation step may be configured in many possible ways, including single-stage, multistage, multistep, or more complicated arrays of two or more units in serial or cascade arrangements.

Although the membrane modules are typically arranged horizontally, a vertical configuration may in some cases be preferred to reduce the risk of particulate deposition on the membrane feed surface.

Returning to FIG. 1, as it relates to the process embodiments of the invention, carbon dioxide-rich stream 106, from container 101, flows at a first feed rate, F1, across the feed side of the membranes 103. A carbon dioxide-depleted residue stream, 107, is withdrawn from the feed side of the membrane and returned to the interior of container 101 at a first residue flow rate, R1. A carbon dioxide-enriched permeate stream, 108, is withdrawn from the permeate side of the membrane at a first permeate flow rate, P1.

Removal of the first, carbon dioxide-enriched permeate stream 108 causes the pressure within the container to drop to less than the pressure outside the container, which is usually atmospheric. This pressure differential gives rise to a flow of air (F2) into the container.

The make-up air enters the process or system as fresh intake air stream, 109, from the ambient outside environment. As described above, this stream is drawn into the system or process in an essentially passive, unregulated manner, in response only to the reduced pressure inside the container brought about by operation of the first membrane separation unit or step. Thus, passage of make-up gas into the container is free of control by sensors, switches, valves, regulators, or any other type of control or regulating equipment.

In other words, line, 116, is open to the outside environment, and connects freely and openly with the interior, 118, of container 101. The sole resistance to gas flow in lines 116 and 117 is the second membrane unit, 104, which is mounted in line 116/117, such that gas drawn into the process or system by a pressure drop within the container passes across the feed side of the membranes within the unit. These membranes, 105, are selectively permeable to oxygen over nitrogen. Make-up air flows across the surface of the second membranes 105 to selectively remove some of the oxygen in the ambient air, to balance the concentrations of carbon dioxide, oxygen, and nitrogen within the container.

The second membrane 105 typically exhibits a selectivity to oxygen over nitrogen of at least 1.5, preferably, at least 2 and, more preferably, at least 2.5, as well as an oxygen permeance of at least 100 gpu, preferably, at least 200 gpu and, more preferably, at least 500 gpu. The second membrane can be driven by compressor or vacuum.

Again, any membranes with suitable performance properties may be used. Particularly preferred membrane materials and modules are as discussed above.

Fresh, ambient air, 119, is drawn into the system through air intake means, 109, which is usually simply an open pipe or tube that connects to the feed inlet side of membrane unit 104. Air intake stream, 120, flows through line 116 and across the feed side of the membranes 105 at a second feed rate, F2. An oxygen-depleted residue stream, 110, is withdrawn from the feed side of the membrane at a second residue flow rate, R2, and returned to the interior of container 101.

Oxygen-enriched permeate stream 111 is withdrawn from the permeate side of the membrane 105 at a second permeate flow rate, P2. Carbon dioxide-enriched first permeate stream 108 and oxygen-enriched second permeate stream 111 may be combined and discharged as exhaust stream, 113, by means of air output means, 112, which may be a single vacuum pump activated by first permeate stream 108. Alternatively (but less preferably), streams 108 and 111 may be discharged as separate streams.

Referring back to FIG. 1, as it relates to the produce storage or shipment system of the invention, the system, 100, includes the following basic elements:
a produce storage or shipping container, 101;
air intake means, 109, for conveying air into the interior, 118, of the container;
air output means, 112, for discharging air from the container;
a first, carbon dioxide-selective membrane unit, 102; and
a second, oxygen-selective membrane unit, 104.

First membrane unit 102 contains a first membrane, 103, that has a first feed side and a first permeate side, and is selective for permeating carbon dioxide over oxygen and nitrogen. The first permeate side is in gas transferring communication with air output means 109, and the first feed side is in gas transferring communication with the interior 118 of container 101.

Second membrane unit 104 contains a second membrane, 105, has a second feed side and a second permeate side, and is selective for permeating oxygen over nitrogen. The second permeate side is in gas transferring communication with the air output means 112. The unit is adapted to accept fresh air intake in a passive, unregulated manner via line 116 on the second feed side, and to deliver an oxygen-depleted second residue stream via line 117 in a passive, unregulated manner to the interior 118 of container 101.

Membranes and modules are as discussed above with respect to the process embodiment of the invention.

Typically, the first membrane unit and the second membrane unit are constructed as a single unit, which is mounted inside the container. (As discussed above with respect to the process embodiment shown in FIG. 1, the two membrane modules are shown outside the container). Air output means 112 typically includes a vacuum pump, which is activated by the carbon dioxide-depleted first permeate stream.

The system typically (but not necessarily) further includes a concentration sensor (not shown) to detect build-up carbon dioxide within the container, and may also include at least one compressor, at least one vacuum pump, and/or means for providing a sweep stream of air, oxygen, or oxygen-enriched air to the first permeate side (not shown). The system may further include a fan (not shown) to increase air flow to the second membrane unit.

We claim:

1. A method for controlling a gas composition in an interior of a storage or shipping container, comprising:
(a) providing a first membrane unit containing a first membrane having a first feed side and a first permeate side, wherein the first membrane exhibits a selectivity to carbon dioxide over oxygen and nitrogen, and wherein the first feed side is in gas-transferring communication with the interior, such that gas may flow from the container, across the first feed side and back to the container;
(b) providing a first driving force for transmembrane permeation from the first feed side to the first permeate side;
(c) passing carbon dioxide-rich air from the interior as a first feed stream across the first feed side at a first feed flow rate, F1 scfm;
(d) withdrawing from the first feed side at a first residue flow rate, R1 scfm, a first residue stream depleted in carbon dioxide compared with the first feed stream;
(e) returning the first residue stream to the interior;
(f) withdrawing from the first permeate side at a first permeate flow rate, P1 scfm, a first permeate stream enriched in carbon dioxide compared with the first feed stream;
(g) discharging the first permeate stream to an outside environment;
(h) providing a second membrane unit containing a second membrane having a second feed side and a second permeate side, wherein the second membrane exhibits a selectivity to oxygen over nitrogen, and wherein the second membrane unit is positioned in an air intake line that provides gas flow, unregulated except by any resistance provided by the second membrane unit, from an outside source of fresh air to the interior;
(i) providing a second driving force for transmembrane permeation from the second feed side to the second permeate side;
(j) allowing a fresh air stream to be drawn into the air intake line in a passive, unregulated manner, thereby creating a second teed stream that passes across the second feed side at a second feed flow rate, F2 scfm;
(k) allowing a second residue stream, having a second residue flow rate, R2 scfm, depleted in oxygen compared with the second feed stream and created by passage of the second feed stream over the second feed side, to be drawn in a passive, unregulated manner into the interior;
(l) withdrawing from the second permeate side at a second permeate flow rate, P2 scfm, a second permeate stream enriched in oxygen compared with the second feed stream;
(m) discharging the second permeate stream to the outside environment;
wherein steps (j) and (k) result substantially in the relationships:
F2=P1+P2, and
R2=F1−R1.

2. The method of claim 1, wherein the first membrane exhibits a selectivity to carbon dioxide over oxygen of at least 2.5.

3. The method of claim 1, wherein the first membrane exhibits a selectivity to carbon dioxide over nitrogen of at least 5.

4. The method of claim 1, wherein the first membrane exhibits a carbon dioxide permeance of at east 400 gpu.

5. The method of claim 1, wherein the first membrane is driven by a compressor, a vacuum pump, or by a sweep stream of air, oxygen, or oxygen-enriched air.

6. The method of claim 1, wherein the second membrane exhibits a selectivity to oxygen over nitrogen of at least 1.5.

7. The method of claim 1, wherein the second membrane exhibits an oxygen permeance of at least 100 gpu.

8. The method of claim 1, wherein the first permeate stream and the second permeate stream are combined and discharged by means of a single vacuum pump.

9. The method of claim 1, wherein the first membrane unit is mounted inside the container.

10. The method of claim 1, wherein the second membrane unit is mounted inside the container.

11. The method of claim 1, wherein the first membrane unit and the second membrane unit are constructed as a single unit.

12. A produce storage or shipment system, wherein the system comprises:
(a) a produce storage or shipping container;
(b) air intake means for conveying air into the container;
(c) air output means for discharging air from the container;
(d) a first membrane unit containing a first membrane having a first feed side and a first permeate side, wherein the first membrane is selective for permeating carbon dioxide over oxygen and nitrogen, and wherein the first permeate side is in gas transferring communication with the air output means and the first feed side is in gas transferring communication with the interior of the container; and
(e) a second membrane unit containing a second membrane having a second feed side and a second permeate side, wherein the second membrane is selective for permeating oxygen over nitrogen, and wherein the second permeate side is in gas transferring communication with the air output means, and wherein the second membrane unit is adapted to accept fresh air intake in a passive, unregulated manner on the second feed side, and to deliver an oxygen-depleted second residue stream in a passive, unregulated manner to the interior of the container.

13. The system of claim 12, wherein the first membrane unit is mounted inside the container.

14. The system of claim 12, wherein the second membrane unit is mounted inside the container.

15. The system of claim 12, wherein the first membrane unit and the second membrane unit are constructed as a single unit.

16. The system of claim 12, wherein the air output means includes a vacuum pump.

17. The system of claim 12, wherein the container includes at least one compressor.

18. The system of claim 12, wherein the container includes at least one vacuum pump.

19. The system of claim 12, further including means for providing a sweep stream of air, oxygen, or oxygen-enriched air to the first permeate side.

20. The system of claim 12, wherein the first membrane exhibits a selectivity to carbon dioxide over oxygen of at least 2.5 under membrane operating conditions.

21. The system of claim 12, wherein the first membrane exhibits a selectivity to carbon dioxide over nitrogen of at least 5 under membrane operating conditions.

22. The system of claim 12, wherein the first membrane exhibits a carbon dioxide permeance of at least 400 gpu under membrane operating conditions.

23. The system of claim 12, wherein the second membrane exhibits a selectivity to oxygen over nitrogen of at least 1.5 under membrane operating conditions.

24. The system of claim 12, wherein the second membrane exhibits an oxygen permeance of at least 100 gpu under membrane operating conditions.
